(19) United States
(12) Patent Application Publication
(10) Pub. No.: US 2009/0180224 A1
(43) Pub. Date: Jul. 16, 2009

(54) ESD PROTECTION DESIGN FOR LOW CAPACITANCE SPECIFICATION

(76) Inventors: Ming-Dou Ker, Hsin-Chu City (TW); Chun Huang, Taipei County (TW); Yuh-Kuang Tseng, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/014,104

(22) Filed: Jan. 15, 2008

(51) Int. Cl. H02H 9/00

(52) U.S. Cl. 361/56

(57) ABSTRACT

An ESD protection circuit with low capacitance, which utilizes ESD protection design for low capacitance specification, includes: an ESD detection circuit, coupled between a first voltage source and a second voltage source, for detecting an ESD voltage to generate a trigger signal; and an ESD protection device, having an end coupled to one of the first voltage source and the second voltage source, and another end coupled to a pad, wherein the ESD protection device performs an ESD protection according to the trigger signal.

### BACKGROUND OF THE INVENTION

1. Field of the Invention

The present invention relates to an ESD protection circuit utilizing ESD protection design for low capacitance specification, and particularly relates to an ESD protection circuit utilizing ESD protection design for low capacitance specification and having an ESD detection circuit operating between V_{DD} and V_{SS}.

2. Description of the Prior Art

Normally, an integrated circuit needs ESD (electrostatic discharge) protection to prevent an internal circuit from being broken by a sudden ESD voltage. FIG. 1 is a circuit diagram of a prior art ESD protection circuit 100. As shown in FIG. 1, the ESD protection circuit 100 includes a first ESD protection device 101, a second ESD protection device 103, and a resistor device 105. The first ESD protection device 101 and the second ESD protection device 103 can be implemented by a MOS, a diode or an SCR (Silicon Controlled Rectifier). The ESD protection circuit 100 is coupled to a pad 107 and an internal circuit 109 to prevent an ESD current flowing to the internal circuit 109 from the pad 107. Normally, the ESD voltage from the pad 107 will be guided out via the first ESD protection device 101 and the second ESD protection device 103. A current will flow through the resistor 105 to enter the internal circuit 109 if the resistor 105 has too small a value, however. The internal circuit 109 is easily protected if the resistor 105 has too large a value, but the related circuit will have increased latency and cannot operate at high speed.

Besides the above-mentioned disadvantages, since circuit design is rapidly improving and the original ESD circuits cannot provide perfect protection, new ESD protection circuits are being developed. FIG. 2 is a circuit diagram of a prior art ESD protection circuit 200, which is disclosed in USA patent publication 2003/0042498. As shown in FIG. 2, the ESD protection circuit 200 includes an ESD detection circuit 201, which is coupled to a pad 203 and an internal circuit 205 for detecting if an ESD voltage occurs. If the detection result is positive, a trigger signal (voltage or current) is generated to conduct the ESD protection device 207 to guide out the ESD voltage. In this example, the ESD protection device 207 includes an N type MOS 211 and a SCR 213. Other detailed operations and structures are disclosed in the above-mentioned USA patent, and thus are omitted for brevity.

As shown in FIG. 2, however, the ESD detection circuit 201 includes a capacitor 209, and the N type MOS 211 also includes a capacitor C, which will affect the signal quality from the pad 203. Such a situation is more apparent in a circuit with high-speed operation.

### SUMMARY OF THE INVENTION

Therefore, the present invention provides an ESD protection circuit, which provides an ESD detection circuit operating between VDD and VSS to decrease parasitic capacitance.

One embodiment of the present invention discloses an ESD protection circuit with low capacitance, which utilizes an ESD protection design for low capacitance specification. The ESD protection circuit comprises: an ESD detection circuit, coupled between a first voltage source and a second voltage source, for detecting an ESD voltage to generate a trigger signal; and an ESD protection device, having an end coupled to one of the first voltage source and the second voltage source, and another end coupled to a pad, wherein the ESD protection device performs an ESD protection according to the trigger signal.

According to the above-mentioned circuit, the effect on the input signal from the pad, which is caused by parasitic capacitance of the ESD detection circuit, can be decreased. Thus the circuit can be applied to an I/O interface circuit that operates at high speed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a circuit diagram of a prior art ESD protection circuit.

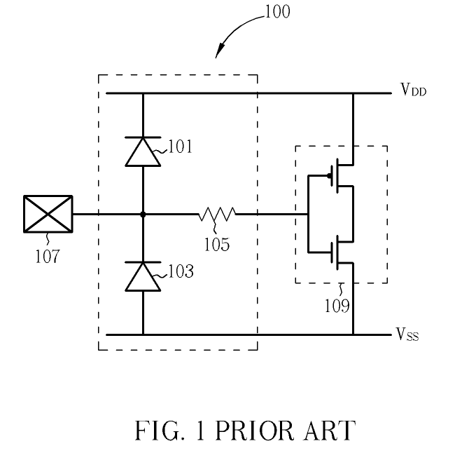

FIG. 2 is a circuit diagram of a prior art ESD protection circuit.

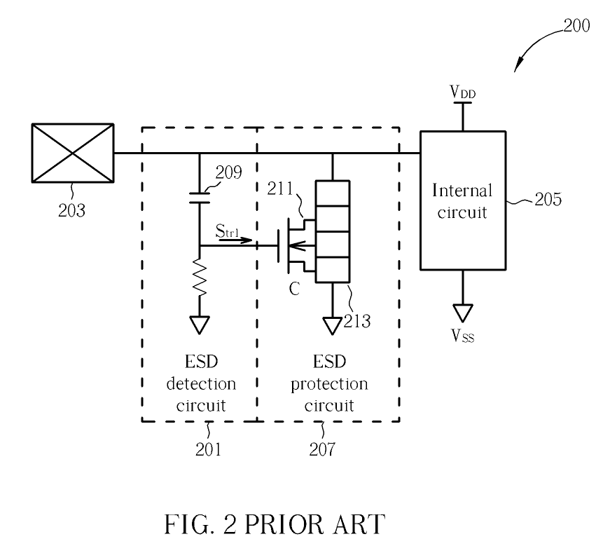

FIG. 3 is a circuit diagram illustrating an ESD protection circuit with low capacitance according to a first embodiment of the present invention.

FIG. 4 is a schematic diagram illustrating detailed structures of the ESD protection circuit shown in FIG. 3.

FIG. 5 is a circuit diagram illustrating an ESD protection circuit with low capacitance according to a second embodiment of the present invention.

FIG. 6 is a circuit diagram illustrating an ESD protection circuit with low capacitance according to a third embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

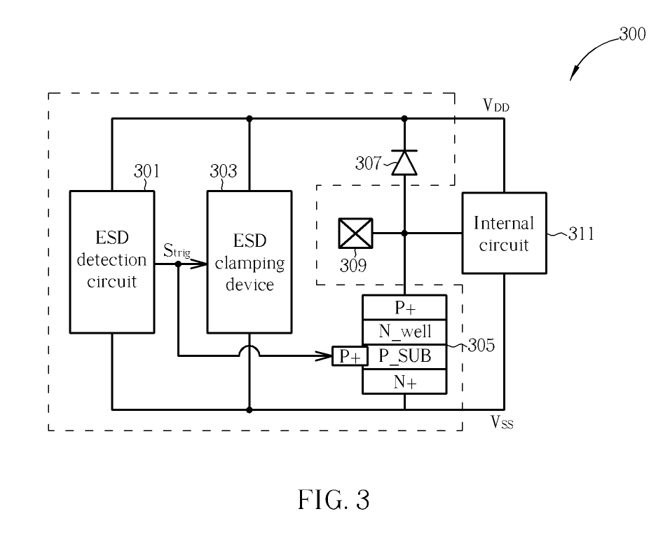

FIG. 3 is a circuit diagram illustrating an ESD protection circuit 300 with low capacitance according to a first embodiment of the present invention, and the ESD protection circuit 300 utilizes ESD protection design for low capacitance specification. As shown in FIG. 3, the ESD protection circuit 300, which has low capacitance, includes an ESD detection circuit 301, an ESD clamping device 303, a P type SCR 305 and a diode 307, for preventing the ESD current from flowing into the internal circuit 311. The ESD detection circuit 301 is coupled to a first voltage source V_{DD} and a second voltage source V_{SS}, for detecting an ESD voltage (i.e. detecting that an ESD event occurs) to generate a trigger signal S_{trig}. The P type SCR 305 performs ESD protection according to the trigger signal S_{trig}(i.e. guides out ESD current). In this embodiment, the trigger signal S_{trig} is a trigger current for controlling the P type SCR 305. The P type SCR 305 can be replaced with other ESD protection devices, however, and if the P type SCR 305 is replaced with other ESD protection devices, the trigger signal S_{trig} is not limited to a trigger current. In this embodiment, the ESD clamping device 303 is utilized to guide out the ESD current generated from the ESD voltage, and is controlled by the trigger signal S_{trig} from the ESD detection circuit 301.

The detailed operations of the ESD protection circuit 300 can be described as follows: when an ESD event occurs and the input pad 309 has a positive voltage relative to the second voltage source V_{SS}, an ESD current flows from the pad 309 via the diode 307 to the first voltage V_{DD} and flows to the ESD clamping device 303 via the ESD detection circuit 301, i.e. the ESD detection circuit 301 generates a trigger signal S_{trig} to the ESD clamping device 303. At the same time, an ESD current flows to the P type SCR 305, i.e. the ESD detection circuit 301 generates a trigger signal S_{trig} to the P type SCR 305. In this case, the ESD clamping device 303 can be powered on to efficiently guide out the ESD current from the first voltage source V_{DD} to the second voltage source V_{SS}, and the P type SCR 305 utilizes the ESD current from the ESD detection circuit 301 to decrease the threshold voltage for powering on such that the power-on speed can increase. Thereby the ESD current from the pad 309 to the second voltage source V_{SS} can be efficiently guided out.

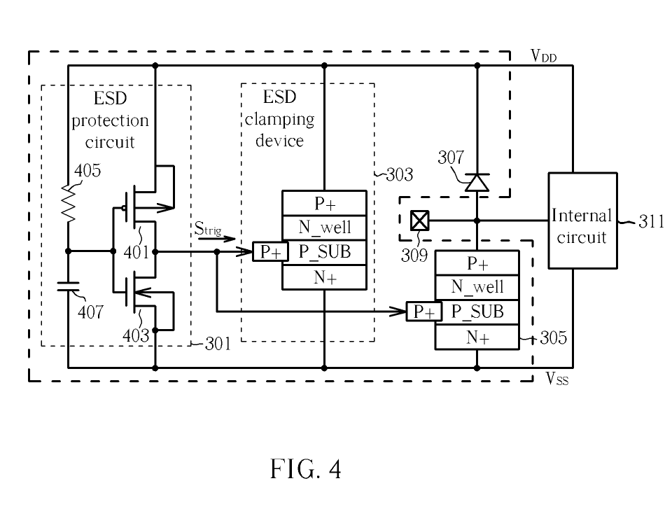

FIG. 4 is a schematic diagram illustrating detailed structures of the ESD protection circuit shown in FIG. 3. In this embodiment, the ESD clamping device 303 is a P type SCR, thus the trigger signal S_{trig} of the ESD clamping device 303 is also a trigger current. The ESD detection circuit 301 includes a P type MOS transistor 401, an N type MOS 403, a resistor 405 and a capacitor 407. The source terminal of the P type MOS transistor 401 is coupled to a first voltage source V_{DD}. The source terminal of the N type MOS transistor 403 is coupled to a second voltage source V_{SS}, and the gate terminal thereof is coupled to a gate terminal of the P type MOS transistor 401. The resistor 405 has an end coupled to a first voltage source V_{DD}, and another end coupled to the gate terminals of the P type MOS transistor 401 and the N type MOS 403. The capacitor 407 has one end coupled to the second voltage source V_{SS}, and another end coupled to the gate terminals of the P type MOS transistor 401 and the N type MOS 403. It should be noted that structures of FIG. 4 are only given as examples, and are not meant to limit the scope of the present invention. Other structures that can reach the same function should also fall within the scope of the present invention.

Besides the ESD protection circuit 300, the ESD protection circuit according to the present invention can be implemented by other structures. For example, the diode 307 of the ESD protection circuit 300 shown in FIG. 3 can be replaced with an N type SCR 501. In this embodiment, the N type SCR 501 and the P type SCR 503 are both controlled by the trigger signal S_{trig} from the ESD detection circuit 505.

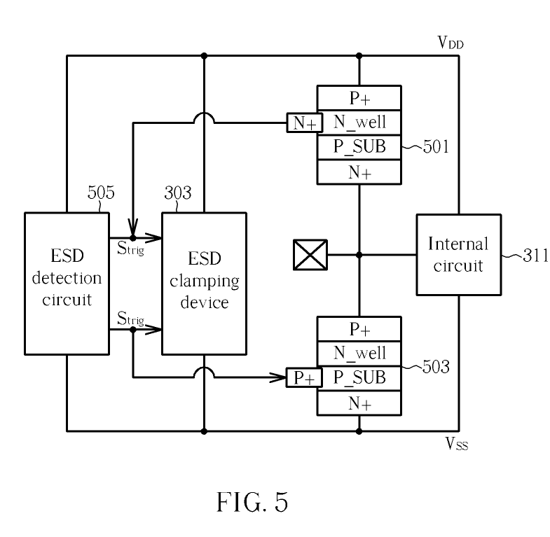

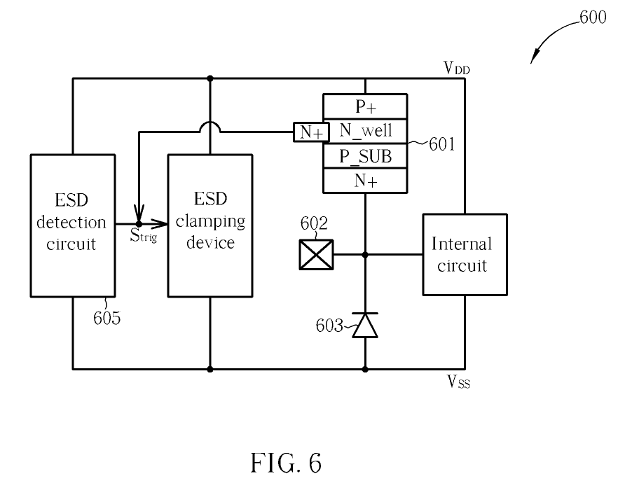

Alternatively, the ESD protection circuit can be implemented by the structure shown in FIG. 6. As shown in FIG. 6, the ESD protection circuit 600 includes an N type SCR 601 and a diode 603. The N type SCR 601 is coupled to an N type SCR 601 and a diode 603. The N type SCR 601 is coupled to a first voltage source V_{DD} and a pad 602, and the N type SCR 601 is guided out via the trigger signal S_{trig} from the ESD detection circuit 605. Also, the diode 603 is coupled between the pad 602 and the second voltage source V_{SS}. The relative operations of the structures shown in FIG. 5 and FIG. 6 can be easily obtained from FIG. 3, and thus are omitted here for brevity.

It should be noted that, although the above-mentioned embodiments utilize P type or N type SCRs as examples, this is not meant to limit the scope of the present invention. Other ESD protection devices that can be controlled by ESD detection circuits, such as MOS transistors, can be applied to the present invention. Furthermore, since the ESD clamping device is used for guiding out ESD current, it is not a necessary device for the present invention. Thus the ESD protection circuit with low capacitance according to the present invention can include no ESD clamping devices.

According to the above-mentioned circuit, since the ESD detection circuit is removed from a location between the input pad and V_{SS} to a location between the V_{DD} and V_{SS}, the effect on the input signal from the pad, which is caused by parasitic capacitance of the ESD detection circuit, can be decreased. Thereby the ESD detection circuit according to the present invention has low parasitic capacitance and is suitable for high speed I/O interface circuit. Furthermore, since the ESD detection circuit can be removed from the location between the input pad and V_{SS}, the chip area can be decreased.

Additionally, if an SCR is utilized for an ESD protection device, a traditional CMOS process latch-up effect can be avoided since the related technique is well developed (for example, 0.13 or advanced CMOS process). Also, since the holding voltage of the SCR is higher than a minimum voltage for chip operation, a latch up can be avoided and the chip can operate normally. Furthermore, a P type SCR has better endurance than a diode and less parasitic capacitance than a diode.

Those skilled in the art will readily observe that numerous modifications and alterations of the device and method may be made while retaining the teachings of the invention.

What is claimed is:

1. An ESD protection circuit with low capacitance, which utilizes ESD protection design for low capacitance specification, comprising:
an ESD detection circuit, coupled between a first voltage source and a second voltage source, for detecting an ESD voltage to generate a trigger signal; and
an ESD protection device, having an end coupled to one of the first voltage source and the second voltage source, and another end coupled to a pad, wherein the ESD protection device performs an ESD protection according to the trigger signal.

2. The ESD protection circuit of claim 1, wherein the ESD protection device is an SCR.

3. The ESD protection circuit of claim 2, wherein the SCR is a P type SCR having an end coupled to the second voltage source, where the ESD protection circuit further includes a diode coupled between the first voltage source and the P type SCR.

4. The ESD protection circuit of claim 2, wherein the SCR is a P type SCR having an end coupled to the second voltage source, where the ESD protection circuit further includes an N type SCR coupled between the first voltage source and the P type SCR.

5. The ESD protection circuit of claim 2, wherein the SCR is an N type SCR having an end coupled to the first voltage source, where the ESD protection circuit further includes a diode coupled between the second voltage source and the N type SCR.

6. The ESD protection circuit of claim 1, further comprising:
an ESD clamping device, coupled to the first voltage source, the second voltage source and the ESD clamping circuit, for operating according to the trigger signal.

7. The ESD protection circuit of claim 1, wherein the ESD detection circuit comprises:
a P type MOS transistor, having a source terminal coupled to the first voltage source;
an N type MOS transistor, having a source terminal coupled to the second voltage source, and having a gate terminal coupled to a gate terminal of the P type MOS transistor;
a resistor, having an end coupled to the first voltage source, and having another end coupled to gate terminals of the P type MOS transistor and the N type MOS transistor; and
a capacitor, having an end coupled to the second voltage source, and having another end coupled to the gates of the P type MOS transistor and the N type MOS transistor.

8. The ESD protection circuit of claim 1, wherein the trigger signal is a trigger current.
